(19) United States
(12) Patent Application Publication
(10) Pub. No.: US 2023/0226846 A1
(43) Pub. Date: Jul. 20, 2023

(54) WHEEL BEARING ASSEMBLY AND METHOD FOR SECURING AT LEAST ONE ATTACHMENT MEANS IN SUCH A WHEEL BEARING ASSEMBLY

(71) Applicant: AKTIEBOLAGET SKF, GOTEBORG (SE)

(72) Inventor: Volker WENDT, Üchtelhausen/Zell (DE)

(21) Appl. No.: 18/093,906

(22) Filed: Jan. 6, 2023

(30) Foreign Application Priority Data
Jan. 17, 2022 (DE) 102022200447.7

(51) Int. Cl. B60B 3/16; B60B 27/00

(52) U.S. Cl. CPC B60B 3/16; B60B 27/0052; B60B 27/0078

(57) ABSTRACT

A wheel bearing assembly includes a bearing unit having first and second bearing rings mounted for relative rotation, the first bearing ring including a flange configured to connect the first bearing ring to a wheel rim, the flange including a plurality of threaded bores. A plurality of stud bolts each having a first portion, a second portion and an intermediate collar separating the first portion from the second portion are mounted in the bores such that the first portions are located in the bores and the first axial face of the intermediate collar abuts the flange. A second axial face and/or a radially outer portion of the intermediate collar includes at least one projection or groove configured to form an interference fit with another component.

### CROSS-REFERENCE

This application claims priority to German patent application no. 10 2022 200 447.7 filed on Jan. 17, 2022, the contents of which are fully incorporated herein by reference.

### TECHNOLOGICAL FIELD

The present disclosure is directed to a wheel bearing assembly with improved attachment elements for securing a wheel to the wheel bearing assembly.

### BACKGROUND

In order to equip a wheel bearing assembly with wheel bolts, a head of the wheel bolt is usually placed behind an installation flange of a part of the wheel bearing assembly. This makes it possible to provide a strong counterpart for an attachment nut that is screwed onto the wheel bolt in order to secure a wheel rim. An attachment torque generates a bolt load in order to attach the wheel rim and even a brake disk to the wheel bearing assembly.

However, there are also bearing assemblies in which there is no space for a bolt behind the installation flange, but rather only for a threaded bolt that is screwed into the bearing flange. However, it is known that especially in wheel bearing assemblies that are subjected to high loads, such as can occur, for example, in vehicles, the bolts can easily loosen and release.

### SUMMARY

It is therefore an aspect of the present disclosure to provide a wheel bearing assembly in which the attachment means for attaching a wheel to the wheel bearing assembly used can be better secured against releasing.

In the following a wheel bearing assembly is described with a bearing unit that has a first bearing ring and a second bearing ring that are rotatable relative to each other. The bearing unit can include a plurality of rolling elements that are disposed between the first and the second bearing ring. For example, the rolling elements can be tapered rollers. However, other rolling element types are also conceivable, such as, for example, balls. Furthermore, the bearing unit can be a preassembled multi-row, in particular double row, bearing unit. Alternatively a single bearing or at least two individual bearings can also form the bearing unit.

Furthermore, the first bearing ring of the bearing unit includes a flange that is configured to connect the first bearing ring with a rim that is configured to carry a wheel and a further element. In addition, at least one attachment means is provided for securing the rim to the flange. The further element can be, for example, a brake disk.

In order to better secure the at least one attachment means against coming loose, the attachment means is configured as a threaded bolt (stud bolt) that has an intermediate collar. The intermediate collar is configured to interact at least partially with the further element in order to secure the attachment means in the flange. Due to the interaction of the further element and the intermediate collar, the attachment means can be secured against the flange of the first bearing ring and cannot come loose. Furthermore, the described wheel bearing assembly has the advantage that a wheel adapter for attaching the rim to the bearing ring can be omitted, and thus the weight of the adapter can be saved.

The intermediate collar can be formed integrally with the threaded bolt. Alternatively, the intermediate collar can be formed as a separate element, for example, as a nut, that can be screwed onto the threaded bolt. The intermediate collar can in particular include a circumferential surface and two axial side surfaces, wherein in the case where the intermediate collar is configured as a separate element, the two axial sides include a through-hole with a thread.

Here the intermediate collar can in particular divide the threaded bolt into a first section and a second section, the two sections each having an axial length. The axial length of the first section can be chosen such that the threaded bolt can be screwed into the flange of the first bearing ring such that an axial surface of the intermediate collar comes into abutment with the flange. The axial length of the second section can in particular be chosen such that it is sufficiently long that the rim as well as a further attachment means, for example, a nut, can be installed onto the second section.

The intermediate collar preferably includes at least one first region that includes at least one interference element that is configured to interact with the further element in an interference-fit manner. The interference-fit element can be configured, for example, to engage into the further element to secure it against releasing even with high loads. In particular, the further element can be configured to deform locally.

For example, the interference-fit element can be configured as a gearing (e.g., a plurality of serrations) and/or have sharp edges. In particular, the first region can be provided in a circumferential surface of the intermediate collar. Alternatively or additionally, the first region can also be provided in one or both axial surfaces of the intermediate collar. Gearings make possible an effective interference fit between two elements.

According to a further preferred embodiment, the intermediate collar further includes a second region that is configured to interact with a tool. This allows an easy screwing in of the attachment means into the flange. Furthermore, the first region and the second region can be arranged in an alternating manner. The second region preferably includes two mutually opposed parallel surfaces that are spaced such that they are graspable by a tool, in particular a wrench.

For example, a dimension of the second region, in particular a separation of the two mutually opposing surfaces, can be selected based on the dimensions of a standard bolt set with a hexagonal head dimension. This makes it possible to tighten the attachment means like a bolt so that a thread load required to secure the attachment means is also achieved. The second region advantageously makes an interference fit possible precisely in the position in which the attachment means has its final tightening position.

According to a further preferred embodiment, a connection between the further element and the interference-fit element is formed by deformation of the further element. By deforming the further element, it is not only possible to dispense with an extra interference-fit element in the further element, but even a counter-piece perfectly matching the interference-fit element in the intermediate collar is generated.

The further element preferably comprises a plurality of through-holes, through which the threaded bolts of the attachment means are introducible, wherein the intermediate collar is configured to at least partially deform a region of the through-holes during securing of the attachment means in the flange of the first bearing ring. The axial forces that are required in order to deform the further element can advantageously be provided by attachment nuts that are used to secure the wheel rim to the attachment means. The wheel rim can thereby be installed in one step and the attachment means secured so that the installation effort is advantageously not further increased.

According to a further aspect, a method is provided for securing at least one attachment means in an above-described wheel bearing assembly. The method comprises the following steps:
introducing the at least one attachment means into a threaded hole of the flange, and possibly attaching the intermediate collar to the threaded bolt of the attachment means, if the intermediate collar is configured as a separate element,
installing the further element on the at least one threaded bolt using a through-hole that is provided in the further element, and
attaching the further element using a further attachment means, in particular a nut, by tightening the further attachment means until the further element lies at least partially over the intermediate collar so that the intermediate collar interacts with the further element in order to secure the attachment means in the flange.

According to another aspect, a wheel bearing assembly includes a bearing unit having a first bearing ring and a second bearing mounted for rotation relative to each other. The first bearing ring including a flange configured to connect the first bearing ring to a wheel rim, and the flange includes a plurality of threaded bores. The assembly also includes a plurality of stud bolts each including a first portion, a second portion and an intermediate collar separating the first portion from the second portion. The intermediate collar has a first axial face, a second axial face and a radially outer portion, and the first portion of each of the plurality of stud bolts is threaded into a respective one of the bores such that the first axial face of the intermediate collar abuts the flange. The second axial face and/or the radially outer portion of the intermediate collar includes at least one projection or groove.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a three-quarter perspective view, partly in section, of a wheel bearing assembly according to the present disclosure.

FIG. 2 is a schematic perspective view of an attachment means of FIG. 1.

FIG. 3 is a schematic perspective view of an intermediate collar of the attachment means of FIG. 2.

FIG. 4 is a schematic side elevational view of a bearing unit of the bearing assembly of FIG. 1.

### DETAILED DESCRIPTION

In the following, identical or functionally equivalent elements are designated by the same reference numbers.

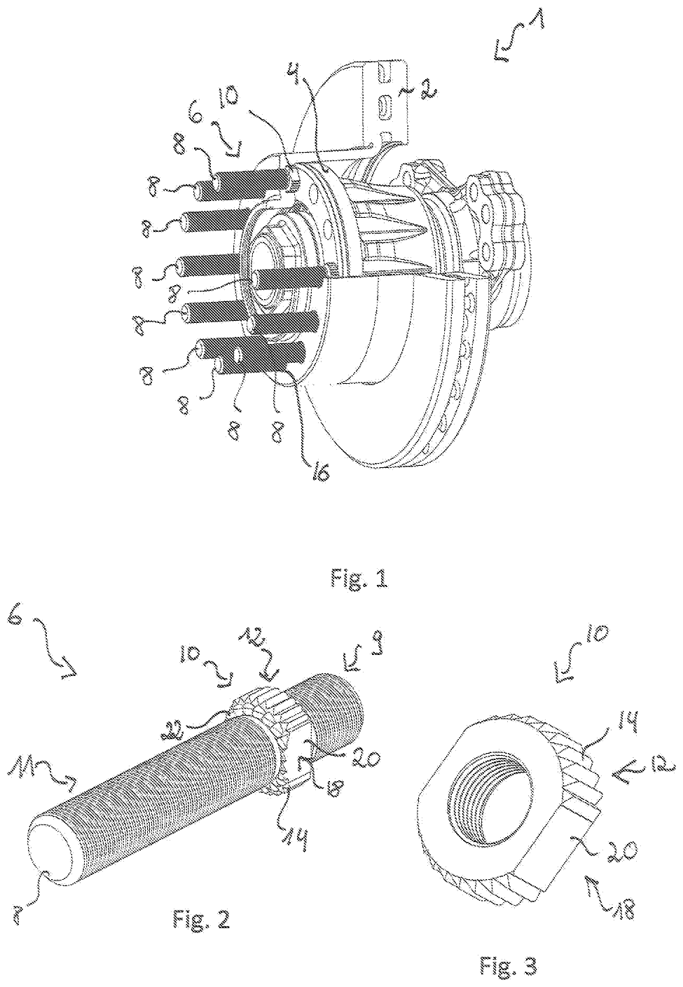

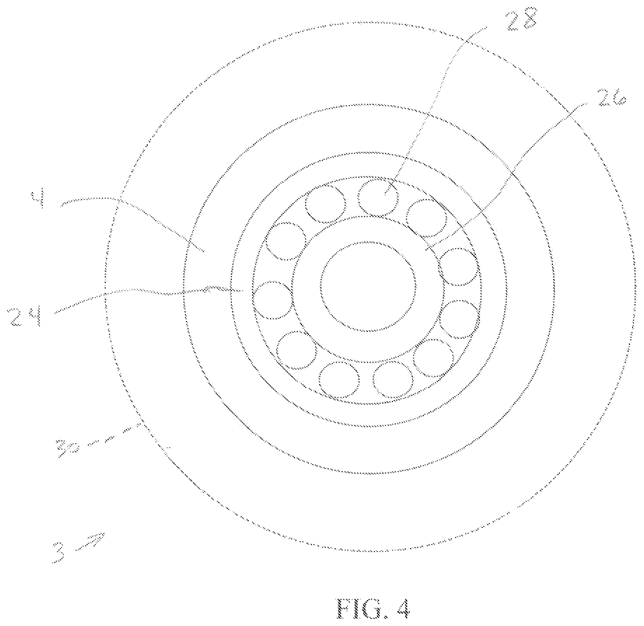

FIG. 1 shows a three-quarter perspective view, partly in section, of a wheel bearing assembly 1 according to a first embodiment. The wheel bearing assembly 1 is in particular a wheel bearing assembly for a motor vehicle and comprises a bearing unit 3 (FIG. 4) that has a first bearing ring 24 and a second bearing ring 26 that are rotatable relative to each other, wherein the first bearing ring includes a flange 4. In particular, the bearing unit can include a plurality of rolling elements 28 that are disposed between the first and the second bearing ring. For example, the rolling elements 28 can be tapered rollers. However, other rolling element types are also conceivable, such as, for example, balls. Furthermore, the bearing unit can be a preassembled multi-row, in particular double row, bearing unit. Alternatively a single bearing or at least two individual bearings can also form the bearing unit. Furthermore, the wheel bearing assembly 1 comprises a brake element 2, in particular a brake disk, to which flange 4 is attachable.

Furthermore, the flange 4 is configured to connect the first bearing ring 24 to a wheel rim 30 or a rim that is configured to carry a wheel. For this purpose, in FIG. 1 a plurality of attachment means 6 are provided by which the rim 30 can be secured to the flange 4 as is described below. In the completely installed state the rim 30 is part of a wheel. Specifically, the rim includes a plurality of holes through which the attachment means can extend.

In the wheel bearing assembly 1 shown in FIG. 1, each attachment means 6 is a threaded bolt 8 (stud bolt) having an intermediate collar 10 (see also FIG. 2). As can be seen in FIG. 2, the intermediate collar 10 divides the threaded bolt 8 into a first section 9 and a second section 11, each of the two sections having an axial length. The axial length of the first section 9 is chosen so that the threaded bolt 8 can be screwed into bores in the flange 4 until an axial surface 13 of the intermediate collar abuts against the flange 4. The axial length of the second section 11 can in particular be chosen such that it is sufficiently long that the rim 30 as well as a further attachment means, for example, a nut, can be installed onto the second section 11.

Furthermore, the intermediate collar 10 is configured so that at least part of the intermediate collar 10 interacts with the brake element 2 to secure the attachment means 6 in the flange 4 against loosening. For this purpose the intermediate collar 10 preferably includes at least one first region 12 that includes at least one interference element 14, such as a projection or a groove, that is configured to interact with the brake element 2 in an interference-fit manner. Alternatively a different element than the brake element 2 can also be provided with which intermediate collar 10 interacts. For example, an annular disk can assume this function.

In particular, the interference element 14 can be configured, for example, to engage into the brake element 2 to prevent a loosening of the attachment means 6 even with high loads and deformations of the wheel bearing assembly 1. For example, the interference element 14 can locally plastically deform the brake element 2 or also a different element that is used as securing means for the attachment means 6. In FIG. 1 the interference element 14 is configured as a gearing (e.g., a plurality of serrations) on a radial circumferential surface of the intermediate collar 10. Alternatively or additionally, the interference element 14 can also have sharp edges.

As can be seen in FIG. 1, the brake element 2 includes a plurality of through-holes 16 through which the threaded bolts 8 of the attachment means 6 are introducible. As already mentioned above, the intermediate collar 10 is configured to at least partially plastically deform a region of the brake element 2 in order to secure the attachment means 6 in the flange 4. This can advantageously be effected in the region of the through-holes 16. For this purpose the axial forces that are required to deform the brake element 4 or the further element can be provided by attachment nuts (not depicted) that are used to secure the wheel rim 30 against the attachment means 6. The wheel rim 30 can thereby be installed in one step, and the attachment means 6 secured so that the installation effort is advantageously not further increased.

FIG. 2 shows a schematic perspective view of an attachment means 6 of FIG. 1 which includes a bolt 8. As can be seen in FIG. 2, the intermediate collar 10 has a second region 18 that is configured to interact with a tool (not depicted). A simple screwing in of the attachment means 6 into the flange 4 can thereby be made possible.

In FIG. 2, the second region 18 comprises two mutually opposed parallel surfaces 20 (in FIG. 2 only one surface 20 can be seen) that are spaced such that they are graspable by a tool, in particular a wrench. For example, a dimensioning of the second region 18, in particular of the two mutually opposed surfaces 20, can be based on a bolt head of a standard bolt set. The attachment means 6 can thereby be tightened like a bolt so that a thread load required for the securing of the attachment means 6 is also achieved. In addition to serrations 14 that are disposed on the radial circumferential surface, the intermediate collar 10 of the attachment means 6 of FIG. 2 also has sharp edges 22, possibly in the form of teeth, that are disposed on the flat axial surfaces of the intermediate collar 10. This makes possible an improved securing of the attachment means 6 in the flange 4 and the brake element 2.

FIG. 3 shows an intermediate collar 10 of the attachment means of FIG. 2. As can be seen from FIG. 3, the intermediate collar 10 can also be embodied as a separate element that can be screwed like a nut onto the threaded bolt 8 of the attachment means.

To secure the attachment means 6 in the flange 4, the first section 9 of the threaded bolt 8 of the attachment means 6 is first screwed into a threaded bore of the flange 4. Depending on whether the intermediate collar 10 is formed integrally with the threaded bolt 8, as is shown in FIGS. 1 and 2, or whether the intermediate collar 10 is present as a separate element, either the attachment means 6 is tightened directly by a suitable tool with the aid of the second region 18, or the intermediate collar 10 is attached to the threaded bolt 8 of the attachment means 6 and fixed after the threaded bolt 8 has already been screwed into the threaded bore of the flange 4.

The brake element 2 is subsequently pushed onto the second section 11 of the attachment means by its through-holes 16 and finally secured with the aid of an attachment nut by tightening of the nut until the brake element lies at least partially over the intermediate collar 10. It is thereby ensured in particular that the region of the intermediate collar 10 provided with the interference-fit element 14 at least partially deforms the brake element 2 and thus secures the attachment means 6 in the flange 4 against an undesired releasing.

In summary, due to the interaction of the brake element 2 and the intermediate collar 10, in particular of the interference element 14, the attachment means 6 is secured against the flange 4 and cannot loosen even under a heavy load. For this purpose, with the aid of an interference-fit element 14 provided on the intermediate collar, the brake disk 2 or an alternative element thereto, such as, for example, an annular disk, is advantageously deformed so that an interference fit is generated. The axial forces that are required in order to deform the brake element 2 can advantageously be provided by attachment nuts that are used to secure the wheel rim 30 to the attachment means 6. The wheel rim can thereby be installed in one step and the attachment means 6 secured so that the installation effort is advantageously not further increased.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved wheel bearing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Wheel bearing assembly
2 Brake element
3 Bearing unit
4 Flange
6 Attachment means
8 Threaded bolt
9 First section
10 Intermediate collar
11 Second section
12 First region
14 Interference-fit element
16 Through-hole
18 Second region
20 Surface
22 Teeth
24 First bearing ring
26 Second bearing ring
28 Rolling element
30 Wheel rim

What is claimed is:

1. A wheel bearing assembly comprising:
a bearing unit having a first bearing ring and a second bearing mounted for rotation relative to each other, the first bearing ring including a flange configured to connect the first bearing ring to a wheel rim, the flange including a plurality of threaded bores; and
a plurality of stud bolts each including a first portion, a second portion and an intermediate collar separating the first portion from the second portion, the intermediate collar having a first axial face, a second axial face and a radially outer portion, the first portion of each of the plurality of stud bolts being threaded into a respective one of the bores such that the first axial face of the intermediate collar abuts the flange,
wherein the second axial face and/or the radially outer portion of the intermediate collar includes at least one projection or groove.

2. The wheel bearing assembly according to claim 1,
wherein the at least one projection or groove is formed on the radially outer portion and comprises a plurality of serrations each having an axial end at the second axial face.

3. The wheel bearing assembly according to claim 1, wherein the at least one projection or groove is formed on the second axial face and comprises at least one tooth.

4. The wheel bearing assembly according to claim 1,
wherein the at least one projection or groove comprises serrations formed on the radially outer portion and a plurality of teeth projecting from the second axial surface.

5. The wheel bearing assembly according to claim 1, wherein the radially outer portion of the intermediate collar includes first and second opposed surfaces configured to interact with a tool.

6. The wheel bearing assembly according to claim 5, wherein first and second opposed surfaces are parallel.

7. The wheel bearing assembly according to claim 1, wherein the intermediate collar is configured integrally with the stud bolt.

8. The wheel bearing assembly according to claim 1,
wherein the intermediate collar is formed separate from the stud bolt and threadedly engaged with the stud bolt.

9. A wheel assembly comprising:
the wheel bearing assembly according to claim 1,
a wheel rim having a plurality of openings, and
a component having an annular portion, the annular portion including a plurality of holes and being located between the flange and the wheel rim,
wherein each of the plurality of stud bolts of the wheel bearing assembly extends through a respective one of the plurality of holes of the annular portion and a respective one of the plurality of openings of the wheel rim, and
wherein the at least one projection or groove of the intermediate collar forms an interference fit with the annular portion.

10. The wheel assembly according to claim 9,
including a plurality of nuts threaded onto the stud bolts, the plurality of nuts pressing the wheel rim against the annular portion and the annular portion against the intermediate collars.

11. The wheel assembly according to claim 9,
wherein the component comprises a brake disk.

12. A method comprising:
providing a wheel bearing assembly according to claim 1,
providing a brake disk having an annular portion with a plurality of holes,
providing a wheel rim having a plurality of openings,
mounting the brake disk on the wheel bearing assembly such that each of the plurality of stud bolts extends through a respective one of the plurality of holes in the brake disk,
after mounting the brake disk, mounting the wheel rim on the wheel bearing assembly such that each of the plurality of stud bolts extends through a respective one of the plurality of openings in the wheel rim, and
pressing the wheel rim axially against the annular portion of the brake disk to press the annular portion of the brake disk against the intermediate collars so that the at least one projection or groove is pressed into the annular portion to form an interference fit with the annular portion.

13. The method according to claim 12,
wherein the pressing comprises placing a nut on each of the plurality of stud bolts and tightening the plurality of nuts against the wheel rim.

14. A wheel assembly comprising:
a wheel bearing assembly including:
a bearing unit having a first bearing ring and a second bearing mounted for rotation relative to each other, the first bearing ring including a flange configured to connect the first bearing ring to a wheel rim, the flange including a plurality of threaded bores; and
a plurality of stud bolts each including a first portion, a second portion and an intermediate collar separating the first portion from the second portion, the intermediate collar having a first axial face, a second axial face and a radially outer portion, the first portion of each of the plurality of stud bolts being threaded into a respective one of the bores such that the first axial face of the intermediate collar abuts the flange;
a wheel rim having a plurality of openings; and
a component having an annular portion, the annular portion including a plurality of holes and being located between the flange and the wheel rim;
wherein each of the plurality of stud bolts of the wheel bearing assembly extends through a respective one of the plurality of holes of the annular portion and a respective one of the plurality of openings of the wheel rim, and
wherein the intermediate collar forms an interference fit with the annular portion.
